(19) United States
(12) Patent Application Publication
(10) Pub. No.: US 2026/0235031 A1
(43) Pub. Date: Aug. 13, 2026

(54) BALANCING DEVICE FOR A ROTOR

(71) Applicant: Rolls-Royce Deutschland Ltd & Co KG, Blankenfelde-Mahlow (DE)

(72) Inventor: Artur TURCU, Bestensee (DE)

(21) Appl. No.: 19/537,829

(22) Filed: Feb. 12, 2026

(30) Foreign Application Priority Data
Feb. 13, 2025 (DE) 10 2025 105 435.5

(51) Int. Cl. F01D 5/02

(52) U.S. Cl. CPC F01D 5/027

(57) ABSTRACT

The disclosure relates to a balancing device for a rotor, including a receiving body that is arranged concentrically with an axis of rotation of the rotor and has a plurality of receiving openings distributed about the axis of rotation, and at least one balancing body that extends along a body longitudinal axis, is formed in an at least partially cylindrical manner and is configured to be received in one of the receiving openings. Provision is made for the balancing body to have a slot that extends parallel to the body longitudinal axis and partially interrupts the balancing body.

### CROSS-REFERENCE TO RELATED APPLICATIONS

This application claims priority to the German patent application DE 102025105435.5, filed on February 13, 2025, which is hereby incorporated by reference in its entirety.

### BACKGROUND

### Technical Field

The present disclosure relates to a balancing device for a rotor, balancing devices for rotors in engines or work machines.

### Description of the Related Art

US10544679B2 discloses a balancing device of the type in question.

Balancing devices ensure true running for rotating devices, in particular machines, by compensating specifically imbalances that arise for example as a result of assembly and/or manufacturing tolerances. In this regard, the balancing device may cause specifically changes in mass, for example through the addition or removal of weight at particular positions of the rotor.

In general, for balancing devices, it is important that they be attached securely during operation, i.e. that the balancing device and/or individual balancing bodies of the balancing device do not move out of their receptacle in an uncontrolled manner. It is desirable to keep assembly effort as low as possible during the balancing operation.

Balancing devices are worthy of further improvement with regard to one or more of the abovementioned aspects.

There is a need to improve the assembly and/or failure safety of a balancing device.

### SUMMARY

The scope of the present disclosure is defined solely by the appended claims and is not affected to any degree by the statements within this summary.

In a first aspect, the disclosure proposes a balancing device. The disclosure proceeds from a balancing device for a rotor, comprising a receiving body that is arranged concentrically with an axis of rotation of the rotor and has a plurality of receiving openings distributed about the axis of rotation, and at least one balancing body that extends along a body longitudinal axis, is formed in an at least partially cylindrical manner and is configured to be received in one of the receiving openings.

The balancing body has a slot that extends parallel to the body longitudinal axis and partially interrupts the balancing body.

For a balancing device, in particular one having discrete balancing bodies, both a secure fit of the balancing bodies during operation and good accessibility and low assembly effort during the attachment of each balancing body are important. Since the balancing body has a slot extending along the body longitudinal axis, elastic deformability, in particular perpendicular to the body longitudinal axis and/or directed radially inwardly, may be achieved in a controlled manner. By means of elastic deformability, it is possible to both insert the balancing body into a receiving opening and subsequently securely retain the balancing body in the receiving body. The slot, in particular when the balancing body and the receiving opening have a defined shape and size, is dimensioned such that a desired force fit, i.e. a defined retention force, is established between the balancing body and the receiving opening. The insertion of the balancing body into the receiving opening and in particular the radially inwardly directed elastic deformation of the balancing body results in a retention force acting radially against the receiving opening. As a result of such a force fit, the dependency on other securing means, for example form-fitting securing means, for example shaft nuts, bolts, securing rings, etc., may advantageously be reduced. In this way, it is possible for additional assembly steps, installation space and/or weight to be saved. It is possible to save costs, since it is possible to dispense with additional fastening elements such as bolts, screws and/or nuts.

In some embodiments, the slot extends all the way through the balancing body in the direction of a body transverse axis perpendicular to the body longitudinal axis. This means that the slot passes all the way through the balancing body, specifically in a direction along the body transverse axis, i.e. transversely to the body longitudinal axis. This advantageously results in greater elasticity, i.e. elastic deformability, of the balancing body.

In some embodiments, the balancing body has, at at least one end of the slot as seen in the direction of the body longitudinal axis, a widened portion, a bore extending parallel to the body transverse axis. This means that one or both ends of the slot, as seen along the body longitudinal axis, has or have an additional removal of material. In this way, sharp edges and associated stress peaks may advantageously be avoided. As a result of a widened portion, additional movement space for the material of the balancing body can be provided, in order in this way to improve the elasticity.

In some embodiments, the balancing body has an opening, a bore, that extends along the body longitudinal axis and all the way through the balancing body. In other words, the balancing body may be formed in an internally hollow manner, specifically with a cavity extending along the body longitudinal axis. By means of such an opening, the elasticity of the balancing body may be improved, to set a defined retention force. The balancing body may, in practice, be in the form of a hollow cylinder. In developments, the opening may have a threaded portion.

In some embodiments, a flattened portion is arranged on a trailing edge of the slot. This may mean that at the point at that the slot meets the outer surface of the balancing body, the surface of the balancing body deviates from its, in particular cylindrical, basic shape. At the trailing edge, the balancing body is reduced in size or flattened such that a plateau is formed. As a result of the flattened portion, movement space for the balancing body within the receiving opening may specifically be created in order reduce mechanical stress peaks, for example during thermal expansion, and/or to simplify assembly.

In some embodiments, the balancing body has a chamfer on at least one end face, and/or for the at least one receiving opening to have a receiving chamfer at an inlet. Such a chamfer on the balancing body and/or a receiving chamfer at the receiving opening may advantageously make it easier to insert the balancing body into the receiving opening. As a result of the avoidance of sharp edges, mechanical stress peaks in the material and a risk of injury during assembly or disassembly may be reduced.

In some embodiments, the balancing body is received in the receiving opening by means of an interference fit or a transition fit. The production of a press fit or transition fit may advantageously be thermally supported in that, before the balancing body is inserted into the receiving opening, the balancing body is cooled down and/or the receiving body is heated up. In this way, taking the different coefficients of thermal expansion of the receiving body and balancing body into account, a clearance fit may temporarily be created for easier assembly, this transitioning into the desired transition fit or interference fit in an end state, i.e. after the imposed change in temperature has abated.

In some embodiments, the receiving opening is a passage opening and/or to have sufficient expansion space to allow an axial expansion of the balancing body. In such a development, there is advantageously sufficient space for the balancing body in the direction of the body longitudinal axis, in order to expand in this direction. In developments in which the receiving opening is a passage opening, the balancing body may advantageously be arranged axially centrally with the receiving body. The receiving body and the at least one balancing body may advantageously be arranged symmetrically with respect to an axial plane.

In some embodiments, the receiving opening and/or the body longitudinal axis is arranged parallel to the axis of rotation.

In some embodiments, the balancing body is produced from a first material and the receiving body from a second material. In particular, the first material may have a higher coefficient of thermal expansion than the second material. As a result of the different coefficients of thermal expansion, the assembly of the balancing body may be improved in that a change in temperature is imposed on the receiving body and/or the balancing body prior to assembly, this allowing the balancing body to be able to move within the receiving opening. After this imposed change in temperature has abated, a force fit, i.e. a retention force between the balancing body and receiving body, is established as a result of the respective coefficients of thermal expansion, this ensuring sufficient securing of the balancing body under operating conditions (e. g. in an expected temperature range).

In some embodiments, the first material is or comprises aluminum, steel or a nickel alloy, and/or the second material is or comprises aluminum, steel, a nickel alloy or titanium.

In a second aspect, a rotor for a machine is provided, having a balancing device of the first aspect of the disclosure. The machine may be, an engine, for example an internal combustion engine or a gas turbine engine, or a work machine.

In a third aspect, a machine in provided, in particular an engine, for example an internal combustion engine or gas turbine engine, or a work machine, having a rotor of the second aspect and/or a balancing device of the first aspect.

The balancing device of the first aspect, the rotor of the second aspect and the machine of the third aspect have identical and similar sub-aspects, as are specified in particular in the dependent claims. In this regard, for the development of one aspect of the disclosure, reference is made to the developments of the other aspects of the disclosure.

### BRIEF DESCRIPTION OF THE DRAWINGS

Embodiments of the disclosure will now be described in the following text with reference to the figures in comparison with the prior art, that is in part also illustrated. The figures are not necessarily intended to illustrate the embodiments to scale; rather, the figures take a schematic and/or slightly distorted form where useful for explanatory purposes.

With regard to additions to the teachings that are directly evident from the figures, reference is made to the relevant prior art. Here, it should be taken into consideration that a wide variety of modifications and changes relating to the form and

detail of an embodiment may be made without departing from the general idea of the disclosure. The features of the disclosure that are disclosed in the description, in the figures and in the claims may be essential both individually and in any desired combination for the development of the disclosure. The scope of the disclosure includes all combinations of at least two of the features disclosed in the description, the figures and/or the claims. The general idea of the disclosure is not limited to the exact form or the detail of the preferred embodiment shown and described in the following text or limited to subject matter that would be restricted by comparison with the subject matter claimed in

the claims. Where dimensional ranges are specified, values lying within the stated limits are intended to be disclosed, and able to be used and claimed as desired, as limit values.

Further advantages, features and details of the disclosure will become apparent from the following description of the preferred embodiments and with reference to the figure, in which:

FIG. 1 shows a perspective view of part of a rotor having a balancing device of the concept of the disclosure,

FIG. 2 shows a detail view of a balancing body of the balancing device shown in FIG. 1, where the balancing body is received in a receiving opening,

FIG. 3 shows a plan view of an individual balancing body,

FIG. 4a shows a perspective view of the balancing body shown in FIG. 3,

FIG. 4b shows a sectional view of the balancing body shown in FIG. 3 and FIG. 4A in an axial section plane,

FIG. 5 shows a schematic view of a gas turbine engine, having a balancing device of the concept of the disclosure.

### DETAILED DESCRIPTION

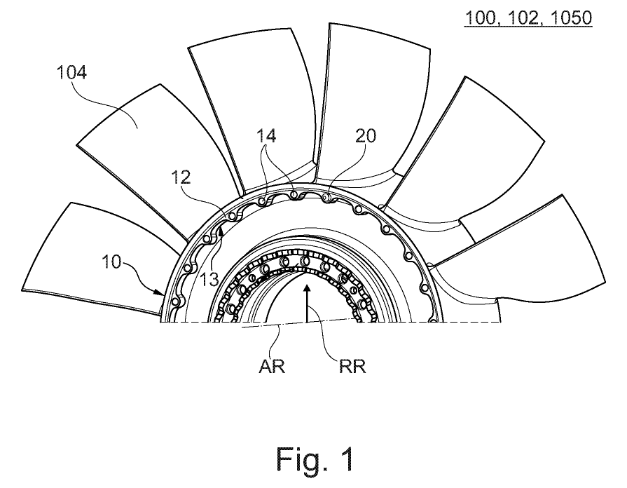

FIG. 1 shows a perspective view of a rotor 100, where, for greater clarity, only a part, namely approximately half of the circumference of the rotor 100 is shown. In the present case, the rotor 100 is in the form of an integrally formed BLISK rotor 102, for example of a compression stage 1050 of a high-pressure compressor 160, having a number of integrally formed rotor blades 104 arranged equidistantly around the circumference. In the present case, a receiving body 12 of a balancing device 10 is integrally formed on the rotor 100. In other embodiments of the disclosure, it is nevertheless possible for the balancing device 10 and/or the receiving body 12 to be in the form of a separate part that may be connected to the rotor 100 via suitable fastening means. The receiving body 12 has a number of receiving openings 14 which, in the present case, are distributed equidistantly around the circumference of the rotor 100 or of the receiving body 12 and each extend through the receiving body 12 in a manner parallel to an axis of rotation AR of the rotor 100. In a region between two adjacent receiving openings 14, the receiving body 12 has, in a weight-saving manner, radial cutouts 13, i.e. a tapering or narrowing of the cross section in a radial direction RR. By way of example, a balancing body 20 is illustrated, that has been inserted into a receiving opening 14.

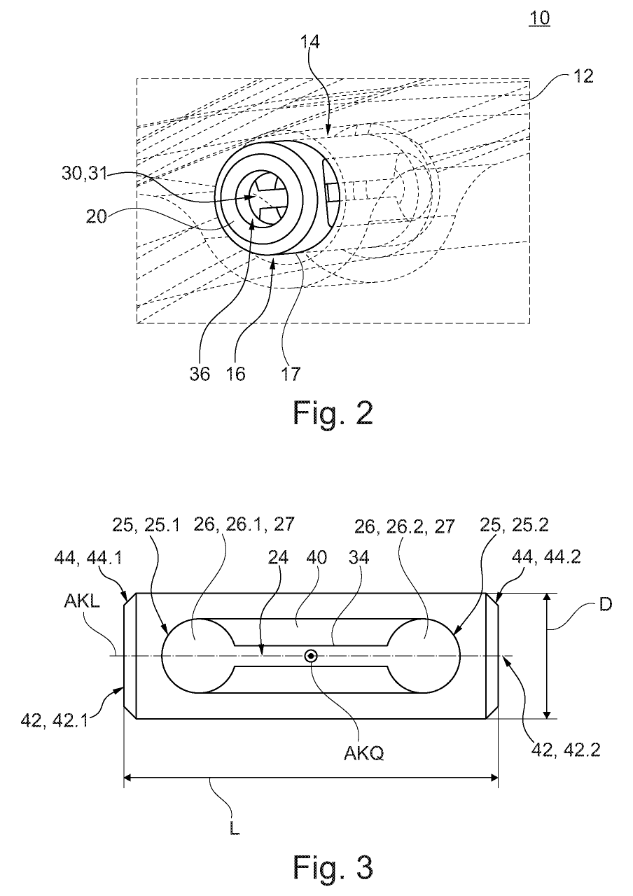

The balancing body 20 is illustrated in detail in FIG. 2 in its installed situation in the receiving opening 14. It is apparent here that the balancing body 20 has an opening 30 in the form of a cylindrical bore 31. It is apparent that the receiving opening 14 has, at an inlet 16, a receiving chamfer 17, that makes it easier to insert the balancing body 20. The opening 30, or the cylindrical bore 31, may, in optional embodiments, have a threaded portion 36. This means that a thread extends at least partially over the inner surface of the opening, that may be brought into engagement with a corresponding external thread on a removal tool (not illustrated here). In this way, a tractive force may be applied effectively to the balancing body 20 in order to extract it from the receiving opening 14. Having said that, it is possible for such a tool to be used for further handling, for example the insertion of the balancing body 20 into the receiving opening 14.

In FIG. 3, the balancing body from FIG. 2 is illustrated on its own and in plan view. The balancing body 20 has a chamfer 44 on each of its end faces 42, namely a first chamfer 44.1 on a first end face 42.1 and a second chamfer 44.2 on a second end face 42.2. Such a chamfer 44 may advantageously make it easier to insert the balancing body 20 into a receiving opening 14. The balancing body 20 has an elongate shape. In the present case, a length L of the balancing body 20 amounts approximately to twice to three times a diameter D of the balancing body 20.

A slot 24 extends along a body longitudinal axis AKL of the balancing body 20. In the direction of a body transverse axis AKQ extending perpendicularly to the figure plane, the slot 24 extends all the way through the balancing body 20. By contrast, in the direction of the body longitudinal axis AKL, the slot 24 does not extend all the way through the balancing body 20 but from a first end 25.1 of the slot 24, arranged in the region of the first end face 42.1, to a second end 25.b arranged in the region of the second end face 42.2. By way of these respective residual material portions between the first end face 42.b and the first end 25.1, and the second end 25.2 and the second end face 42.2, the balancing body 20 forms a cross section that is closed in the drawing plane and extends around the slot 24, having good elastic properties in a direction perpendicular to the body longitudinal axis AKL and perpendicular to the body transverse axis AKQ.

The slot 24 has, at each of its ends 25, a widened portion 26 in the form of a bore 27. The slot 24 has a first widened portion 26.1 at its first end 25.1 and a second widened portion 26.2 at its second end 25.2. In addition to the bores 27, shown here, having a cylindrical shape, the widened portion 26 may, in other embodiments, have other shapes, for example elliptical or polygonal shapes, where the latter may be formed preferably with rounded edges.

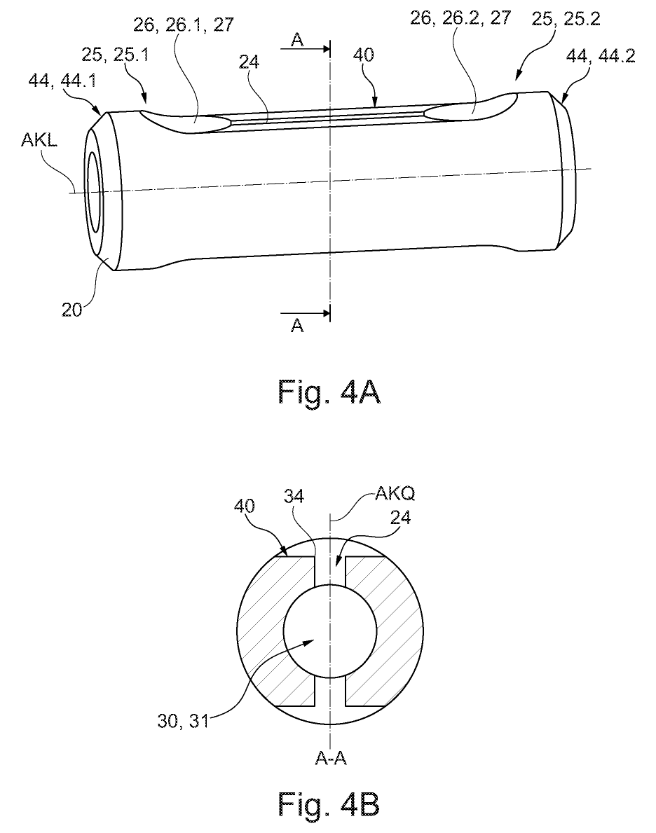

FIG. 4A shows the balancing body 20 shown in FIG. 2 and FIG. 3 in a further, perspective stand-alone illustration. In this case, in particular a flattened portion 40 is discernible, that extends along the slot 24 at a trailing edge 34 and forms a plateau. The flattened portion 40 is substantially a local change in the intended geometry – which is cylindrical in the present case – of the balancing body 20, brought about by a reduction in the volume of the balancing body 20 at the point at which the slot 24 meets the outer surface of the balancing body 20. As a result, a free buffer volume is advantageously provided between the receiving opening 14 and balancing body 20, with the result that mechanical stress peaks, that may stress the receiving body 12, may be reduced.

In FIG. 4B, the balancing body 20 shown in FIG. 4A is illustrated in a sectional view, where the section plane is arranged perpendicular to the body longitudinal axis AKL. The section plane A-A is indicated in FIG. 4A.

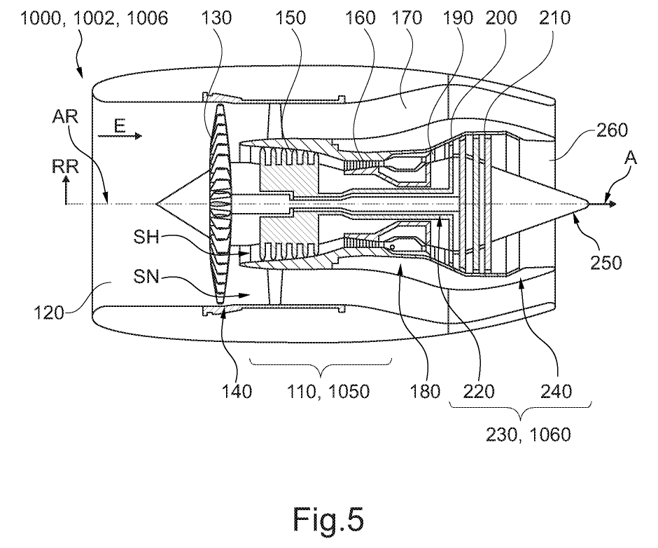

FIG. 5 schematically shows, in a sectional illustration, a gas turbine engine 1000. Engine components are arranged successively along an engine longitudinal axis A of the gas turbine engine 1000, that corresponds in the present case to the axis of rotation AR. At the inlet 120, air is drawn in along an inlet direction E by means of a fan 130. This fan 130 is arranged in a fan housing 140 and is driven by a low-pressure turbine 210 of a turbine 230 via a rotor shaft 220. The turbine 230 includes at least one turbine stage 1060, and adjoins a compressor 110, that has at least one high-pressure compressor 160 and optionally, as shown here, a low-pressure compressor 150 and/or a medium-pressure compressor. The compressor 110, or in each case the high-pressure compressor 160 and the low-pressure compressor 150, has at least one compressor stage 1050. To generate thrust, the fan 130 supplies the low-pressure compressor 150 and the high-pressure compressor 160 and a bypass duct 170 with air. This results in a main flow SH, that passes through the core of the gas turbine 1000,

and a secondary flow SN, that passes through the bypass duct 170. The air compressed in the compressor 150, 160 is mixed with fuel in the combustion chamber 180 and combusted. By way of the generated hot gas, the turbine 230, that may include at least one high-pressure turbine 190, optionally, as shown here, a medium-pressure turbine 200 and optionally a low-pressure turbine 210, is driven. The energy released during the combustion is used by the turbine 230 to drive the compressor 110 and the fan 130, in order then to generate the necessary thrust via the air conveyed through the bypass duct 170. Both the secondary flow SN from the bypass duct 170 and the main flow SH flow out via an outlet 260. The outlet 260 usually has a thrust nozzle with a centrally arranged outlet cone 250. For noise reduction, a mixer is provided, as part of a mixer group 240, in the region of the outlet. As a result of the particular contour of the mixer, the main stream from the core flow and the secondary flow from the bypass duct 170 of the gas turbine 1000 are deflected and mixed such that the resultant swirls reduce the audible noise level.

The proposed solution may be used in gas turbines of different designs, for example in any desired kind of gas turbine engine, for example in an open-rotor or a turboprop engine or a geared turbofan, or stationary gas turbines or other rotating machines.

1. A balancing device for a rotor, comprising:
a receiving body that is arranged concentrically with an axis of rotation of the rotor and has a plurality of receiving openings distributed about the axis of rotation, and
at least one balancing body that extends along a body longitudinal axis, is formed in an at least partially cylindrical manner and is configured to be received in one of the receiving openings,
wherein
the balancing body has a slot that extends parallel to the body longitudinal axis and partially interrupts the balancing body.

2. The balancing device of claim 1, wherein the slot extends all the way through the balancing body in the direction of a body transverse axis perpendicular to the body longitudinal axis.

3. The balancing device of claim 1, wherein the balancing body has, at at least one end of the slot as seen in the direction of the body longitudinal axis, a widened portion.

4. The balancing device of claim 1, wherein the balancing body has an opening, that extends along the body longitudinal axis and all the way through the balancing body.

5. The balancing device of claim 1, wherein a flattened portion is arranged on a trailing edge of the slot.

6. The balancing device of claim 1, wherein
the balancing body has a chamfer on at least one end face, and/or
the at least one receiving opening has a receiving chamfer at an inlet.

7. The balancing device of claim 1, wherein the balancing body is received in the receiving opening by means of an interference fit or a transition fit.

8. The balancing device of claim 1, wherein the receiving opening is a passage opening and/or has sufficient expansion space to allow an axial expansion of the balancing body.

9. The balancing device of claim 1, wherein the receiving opening and/or the body longitudinal axis is arranged parallel to the axis of rotation.

10. The balancing device of claim 1, wherein the balancing body is produced from a first material and the receiving body from a second material, wherein the first material has a higher coefficient of thermal expansion than the second material.

11. The balancing device of claim 1, wherein
the first material is or comprises aluminum, steel or a nickel alloy, and/or
the second material is or comprises aluminum, steel, a nickel alloy or titanium.

12. A rotor for a machine, an engine, an internal combustion engine, a gas turbine engine, or a work machine, having a balancing device of claim 1.

13. A machine, an engine, an internal combustion engine, a gas turbine engine, or a work machine, having the rotor of claim 12.
